(19) United States
(12) Patent Application Publication
(10) Pub. No.: US 2024/0140232 A1
(43) Pub. Date: May 2, 2024

(54) DEVICE ABLE TO BE FITTED TO AN ELECTRIC VEHICLE FOR RECHARGING SAME

(71) Applicant: GULPLUG, GRENOBLE (FR)

(72) Inventors: Ronan Troufflard, St Egrève (FR); Stéphane Wolozan, Echirolles (FR); Antoine Lefaucheux, Voiron (FR)

(21) Appl. No.: 18/548,568

(22) PCT Filed: Feb. 25, 2022
(86) PCT No.: PCT/EP2022/054769

§ 371 Date: Aug. 31, 2023

(30) Foreign Application Priority Data
Mar. 1, 2021 (FR) FR2101962

(51) Int. Cl. B60L 53/35; B60L 53/16; B60L 53/18

(52) U.S. Cl. CPC B60L 53/35; B60L 53/16; B60L 53/18

(57) ABSTRACT

A device, fittable on an electrical apparatus with a view to recharging the apparatus, includes a storage unit, a movement assembly, and first mechanical means. The storage unit includes a cable bearing, at its end, an electrical plug. The movement assembly is for setting the cable in motion. The first mechanical means are included for actuating the assembly. The first mechanical means are configured to actuate the assembly with a view to releasing the cable outwardly from the storage unit or retracting the cable into the storage unit. A storage casing houses the electrical plug when the cable is retracted. The storage casing bears an obturating device that includes a cover that is actuatable to open or close.

### CROSS REFERENCE TO RELATED APPLICATIONS

This application is a national phase entry under 35 U.S.C. § 371 of International Patent Application PCT/EP2022/054769, filed Feb. 25, 2022, designating the United States of America and published as International Patent Publication WO 2022/184566 A1 on Sep. 9, 2022, which claims the benefit under Article 8 of the Patent Cooperation Treaty to French Patent Application Serial No. FR2101962, filed Mar. 1, 2021.

### TECHNICAL FIELD

The present disclosure relates to a device fittable on an apparatus such as an electric vehicle with a view to recharging it.

The disclosure also relates to an electrical connection system including the device.

### BACKGROUND

Various solutions for recharging an electric vehicle have already been proposed. By electric vehicle, what is of course meant is a vehicle that is 100% electric or a plug-in hybrid (for example, combining electric and internal combustion or electric and hydrogen). Many patents on induction charging systems have thus been filed. In these solutions, a primary coil connected to an electric supply circuit and a secondary coil connected to the battery of the electric vehicle are positioned facing each other so as to generate an induced recharging current in the secondary coil. These induction-based solutions are particularly advantageous because they do not involve any human intervention. However, they also have a certain number of drawbacks that make them difficult to deploy on a large scale. These drawbacks are as follows:
they require the secondary coil to be positioned perfectly with respect to the primary coil, to maximize efficiency;
they require particularly complex and expensive infrastructure;
adjustment of the relative positioning of the two coils may require particular means to be used, this further increasing the complexity of the infrastructure and its cost;
they emit high-frequency electromagnetic radiation, which may interfere with nearby electrical devices and cause damage to health.

It would therefore be desirable to provide an electrical connection solution that has certain advantages of induction-based solutions, notably the absence of human intervention, but that does not have all the drawbacks thereof. Patent application WO2017/216458A1 thus describes an electrical connection device taking the form of a pedestal incorporating a magnetically attractive electrical socket. The electrical socket is positioned centrally, and the pedestal has a surface that skirts the connection front face of the electrical socket. The electrical socket is equipped with magnetic means allowing it to attract, via a magnetic effect, an electrical plug equipped with corresponding magnetic means. The electrical connection is made between the socket and the plug when the two elements are affixed by the magnetic effect. The plug is connected to an electrical apparatus, such as, for example, the supply assembly of an electric vehicle. In one particular embodiment, the device comprises a plurality of coils of annular shape that are incorporated into the pedestal in such a way as to be positioned concentrically around the electrical socket. In operation, the pedestal incorporating the electrical socket is, for example, placed on the ground and connected to the mains by an electrical cable. The plug is released from the apparatus when near to the pedestal. The coils are controlled by a control sequence designed to guide the plug toward the center of the pedestal and therefore toward the electrical socket. Connection is made via the magnetic attraction present between the respective magnetic means of the socket and plug.

Two-part electrical connection systems that use a magnetic effect to attract a first part toward a second part and to make an electrical connection when the two parts are coupled are well known in the prior art. They are notably described in patent applications WO2014/202849A1, WO2012/032230A1, EP2595252A1 and EP1667459A1. This is also the case for patent EP2461429B1, which describes an electrical connection system in which a plug is attracted by a magnetic effect toward a casing in order to make an electrical connection.

To recharge an electrical apparatus such as an electric vehicle, it is essential to provide a device that is able to fit perfectly on the vehicle to be recharged, whether it is a vehicle already in use or a new vehicle manufactured on an existing or future platform. This device is advantageously intended to remain permanently in the vehicle or to be easily replaceable, in whole or in part. This device, which bears the electrical plug, must thus meet the following objectives:
be compact enough to be easily installed in the vehicle;
allow the plug to be deployed when the presence of the socket is detected nearby;
ensure that the plug always ends up in the same final position, in order to make connection with the socket reliable in all situations;
be dust- and water-tight; and
meet all the operating conditions of such a vehicle, in terms of electromagnetic compatibility (EMC), resistance to vibration, impacts and temperature, etc.

The aim of the disclosure is to provide a device capable of meeting one or more of the aforementioned objectives.

### BRIEF SUMMARY

One or more of the aforementioned objectives are achieved by a device fittable on an electrical apparatus with a view to recharging it, the device comprising:
a storage unit comprising a cable bearing at its end an electrical plug, a movement assembly for setting the cable in motion, first mechanical means for actuating the assembly, which are configured to actuate the assembly with a view to releasing the cable outwardly from the storage unit or to retracting the cable into the storage unit,
a storage casing in which the electrical plug is housed when the cable is retracted, the storage casing bearing an obturating device that comprises a cover that is actuatable to open or close,
second mechanical actuating means controlled to open or close the cover, and
control means for controlling the first mechanical actuating means so as to release or retract the cable and for controlling the second mechanical actuating means so as to open or close the cover, the control means being configured to receive an electrical control signal from detecting means or a control unit.

According to one particularity, the device comprises a guiding device comprising a duct for guiding the cable that is fastened to the storage unit and arranged to guide the cable, the duct having a free end bearing the storage casing.

According to another particularity, the storage casing comprises a base and a bell that are actuatable to rotate with respect to each other by the second actuating means.

According to another particularity, the cover is composed of a flexible obturating sleeve having a first end and a second end, its second end being folded over the first end so as to have two coaxial lateral flanks connected by a fold, the first end being fastened to the base and the second end to the bell.

According to another particularity, the second actuating means comprise a gearwheel engaged with teeth formed on the bell.

According to another particularity, the storage casing comprises a first sensor for sensing the end of a closing movement of the cover and a second sensor for sensing the end of an opening movement of the cover, the sensors each being arranged to interact with a finger that is securely fastened to the bell.

According to a first example of an embodiment, the movement assembly comprises a winder on which the cable is intended to be wound.

According to one particularity, the storage unit comprises a first sensor arranged to monitor the length of cable unwound from the winder.

According to another particularity, the storage unit comprises a second sensor arranged to monitor the length of cable wound on the winder.

According to a second example of an embodiment, the movement assembly comprises a carriage that is translatable on a slide mechanism.

The disclosure also relates to an electrical connection system comprising an electrical plug and an electrical socket that are able to be coupled together to make an electrical connection, the electrical plug being borne by a device such as defined above.

According to one particularity, the system comprises a pedestal comprising a jacket having a central part occupied by the electrical socket.

According to another particularity, the system comprises a plurality of guide coils housed in the jacket of the pedestal and arranged concentrically around the electrical socket, and control means configured to execute a control sequence in which each coil is independently activatable to move the electrical plug closer to the electrical socket through creation of a magnetic field.

The disclosure also relates to an electric or hybrid vehicle, the vehicle comprising a chassis to which the device such as defined above is fastened.

### BRIEF DESCRIPTION OF THE DRAWINGS

Other features and advantages will become clear in the following detailed description given with reference to the appended drawings in which:

FIG. 1 schematically shows the principle of an electrical connection system including a device according to embodiments of the disclosure;

FIG. 2 schematically shows the architecture of the device according to embodiments of the disclosure;

FIGS. 3A and 3B show, seen from the side, a first example of an embodiment of the device of the disclosure, in the disconnected state and in the connected state, respectively;

FIGS. 4 and 5 show the storage unit of the device according to embodiments of the disclosure of FIGS. 3A and 3B, seen in perspective and from the side, respectively;

FIGS. 6A and 6B show, seen in perspective, a second example of an embodiment of the device of the disclosure;

FIGS. 7A, 7B and 8A, 8B show the storage casing employed in the device according to embodiments of the disclosure and illustrate the operating principle of its obturating system, between its closed position and its open position; and

FIGS. 9A to 9C illustrate the operating principle of the device integrated into a motor vehicle.

### DETAILED DESCRIPTION

The disclosure relates to a device 5 capable of being fastened to an electrical apparatus 4, this device comprising an electrical plug 2 (hereinafter the plug 2) that is connected to the electrical supply assembly of this apparatus 4 by a cable and intended to be electrically connected to an electrical socket 1 (hereinafter the socket 1) that is connected to an electrical grid R. Advantageously, the apparatus 4 may be the electrical supply assembly of an electric vehicle V, this assembly including one or more batteries to be recharged. As indicated above, the vehicle may be 100% electric or a plug-in hybrid.

In the present description, electrical connection between the plug and the socket must be understood broadly. It includes connection by simple contact, for example by means of flat contacts, and plugged-in connection, for example by means of interaction between a clip or pin and a socket or equivalent. Other electrical connection solutions could of course be envisioned.

Non-limitingly, the plug 2 is intended to be mechanically coupled to the socket 1 with a view to making mechanical connections between their respective electrical contacts and making an electrical connection. According to one advantageous aspect of embodiments of the disclosure, mechanical coupling between the plug 2 and the socket 1 is achieved via a magnetic effect. A suitable magnetic architecture thus makes it possible to ensure the plug 2 is affixed against the socket 1. When the plug 2 is plugged into the socket 1, the front part of the plug 2 thus abuts mechanically against the front part of the socket 1.

For the remainder of the description, an axial main direction (A) is defined, which direction corresponds to a main direction in which the plug 2 is brought closer to the socket 1 and which thus corresponds to the axis of the socket 1 along which the electrical connection is made.

The system advantageously allows the plug 2 to be mechanically connected to the socket 1 automatically, without intervention by an operator or a robot, using only magnetic and gravitational means.

In the remainder of the description, the terms “front” and “rear,” “top” and “bottom,” and “upper” and “lower” are to be considered having regard to the longitudinal position along the main direction (A).

Non-limitingly, the socket 1 may be integrated into a pedestal 3 to be placed on a holder (for example, the ground S—the main direction (A) is then orthogonal to the ground). The pedestal 3 may comprise one or more connectors 30 allowing it to be connected to the electrical grid R and to a communication system. Electrical connections integrated into the pedestal 3 allow the electrical socket 1 to be connected to the connectors 30.

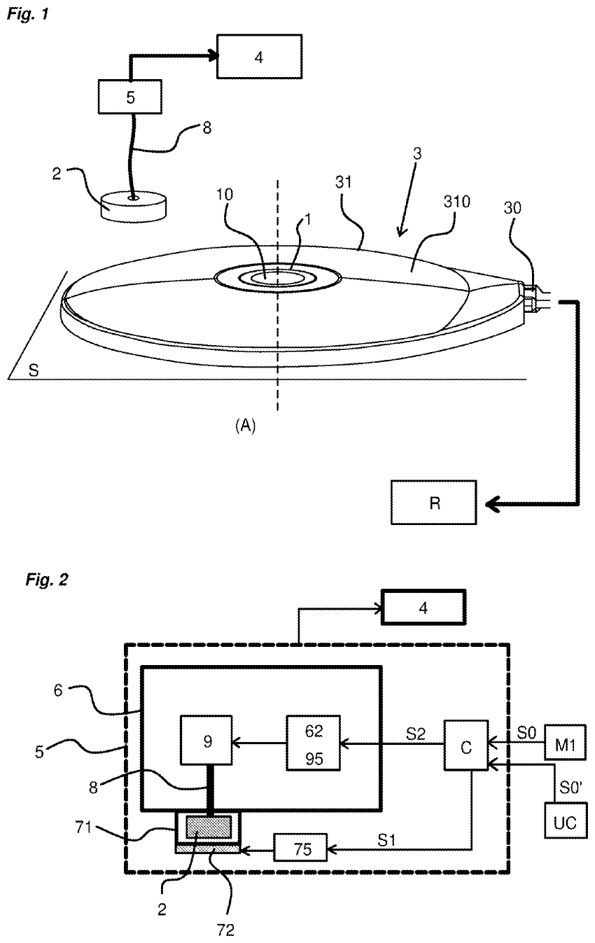

With reference to FIG. 1, the pedestal 3 comprises a closed jacket 31, the central part of which is occupied by the socket 1.

The electrical socket 1 comprises a front land 10 via which it is mechanically coupled to the plug 2. This front land 10 may be of any suitable shape, flat or curved, concave or convex.

The jacket 31 skirts the socket 1 and defines a front surface 310 that skirts the front land 10 of the socket 1. This front surface 310 lies beyond the front land 10 of the socket 1 and is not dedicated to connection. Under this surface, the jacket 31 may incorporate magnetic and/or mechanical guiding means suitable for guiding the plug 2 toward the socket 1 as the plug 2 approaches. Non-limitingly, patent application No. WO2017/216458A1 describes an operating principle whereby the plug 2 is connected to the socket 1 by executing a control sequence of concentric coils integrated into the jacket.

The front land 10 of the socket 1 is oriented transversely to the main direction (A). The front surface 310 of the pedestal 3, around the socket 1, may be planar in the same plane as that formed by the front land 10 of the socket 1, or of a concave or convex curved shape (as in the appended figures).

The socket 1 may comprise a first casing, advantageously of circular cross-section, bearing the front land 10. This first casing may be integrated into the casing forming the jacket 31 of the pedestal 3.

The socket 1 is equipped with first magnetic means housed in its casing allowing it to attract the plug 2, which is equipped with corresponding second magnetic means. When the plug 2 is affixed via a magnetic effect to the socket 1, an electrical connection is also made between first electrical contact members of the socket 1 and second electrical contact members of the plug 2.

The magnetic architecture used allows the plug 2 to be affixed to the socket 1 via a magnetic effect. Various magnetic architectures, allowing the plug 2 to be affixed to the socket 1, are notably described in patent application EP3317926A1. These are applicable to the present disclosure but are to be considered non-limiting.

It will be noted that the plug 2 advantageously comprises no moving mechanical parts.

According to embodiments of the disclosure, the device 5 bearing the plug 2 is intended to be fitted on the vehicle V and to remain permanently on the vehicle. It comprises fastening means for fastening it to part of the vehicle and electrical connection means for connecting it to the electrical supply assembly of the vehicle. It may also comprise:
communication means configured to communicate with the battery management system (BMS) of the electrical supply assembly of the vehicle;
control means C, which are optionally integrated into the battery management system.

The device 5 may be placed in various places on the vehicle, at the front, at the rear, and optionally in a suitable housing. Its location will notably depend on the architecture of the vehicle but also on whether the device is intended to be integrated into a vehicle already present on the market or during its manufacturing process.

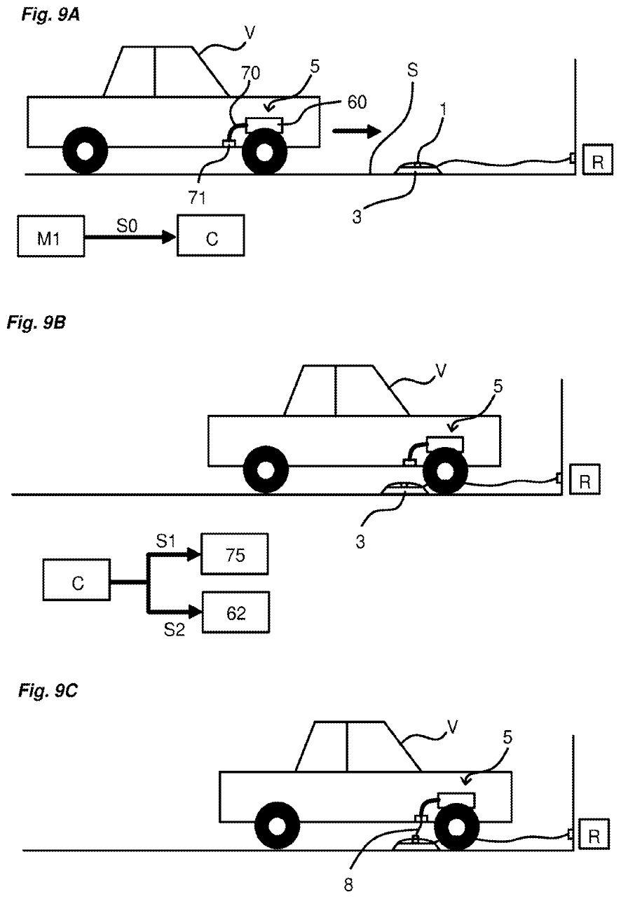

Non-limitingly, the control means C may receive a first electrical control signal S0, S0′ from detecting means M1 or from a central unit UC (see notably FIGS. 9A to 9C). On receipt of this signal, the control means C may activate the device 5.

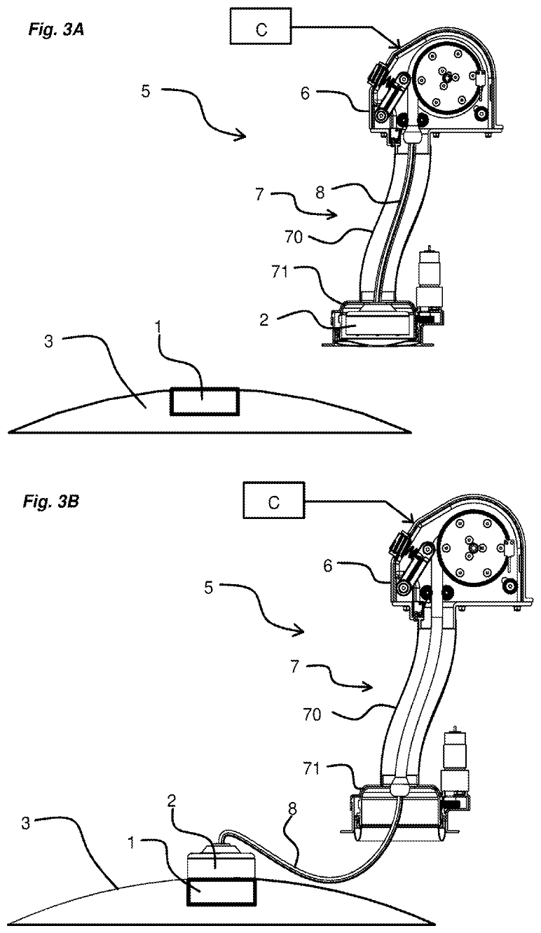

With reference to FIG. 2, the device 5 mainly comprises the following elements:
a unit, referred to as the storage unit 6, for storing a cable 8, the cable 8 bearing the plug 2 at its end;
a storage casing 71 in which the plug 2 is housed and which bears a cover that is actuatable to open or close;

The storage unit 6 also comprises a movement assembly 9 for setting the cable 8 in motion, which is controlled to release the cable 8 outwardly and to deploy the plug 2 from its storage casing 71 (deployed position of the plug) or to retract the cable 8 with a view to storing the plug in its storage casing 71 (retracted position of the plug). These moving means 9 (which may also be referred to herein as the movement assembly 9) are mechanical.

The cable 8 has a free end bearing the plug 2 and an opposite end intended to be connected to the electrical supply assembly of the vehicle. The cable 8 interacts with the movement assembly 9 so as to be released outwardly from the storage unit 6 or to be retracted into the storage unit 6. First mechanical actuating means 62, 95 are provided to control the movement of the movable part and to cause the cable 8 and the plug 2 to move between at least two positions. These first means are configured to receive the control signal S2 from the control means C.

Non-limitingly, the device according to embodiments of the disclosure is arranged to lower the cable 8 in a substantially vertical direction, in the main direction (A). The two positions of the plug 2 are situated plumb with each other.

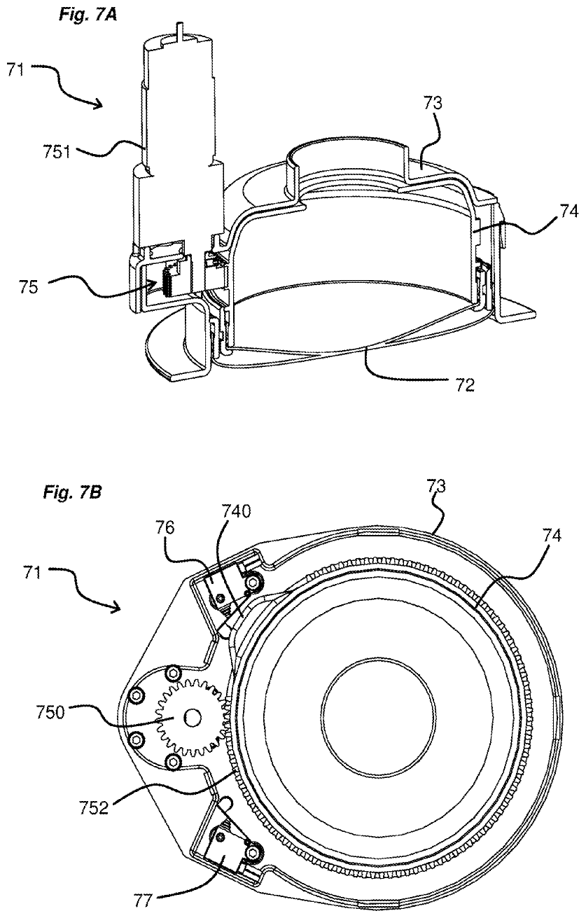

It will be seen that the cable 8 may be stripped so as to expose all of its constituent wires 81. This solution employing a plurality of wires 81 may potentially make it possible to increase the mechanical flexibility of the cable 8 and thus make it easier to bend and to reduce its overall heightwise bulk inside the storage unit 6. This solution may notably be employed in conjunction with the second embodiment of the device (FIG. 6A and FIG. 6B) described below.

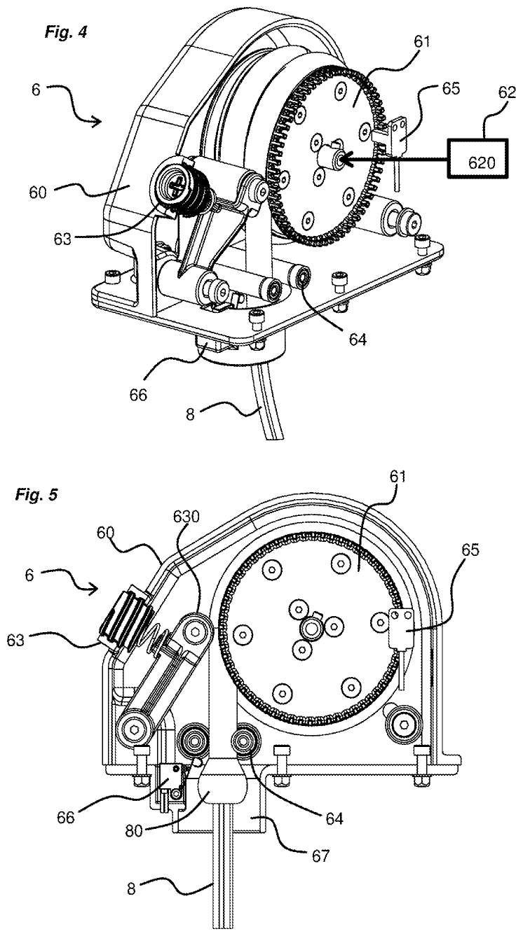

Advantageously, as shown in FIG. 3A and FIG. 3B, it will be seen that the device 5 may also comprise a device 7 for guiding the cable 8.

According to one particular aspect of embodiments of the disclosure, the various elements of the device 5 are, for example, composed of modules that are easily able to be assembled together, making it possible to match the configuration of the accommodating housing in the vehicle.

Likewise, seen from the exterior, the device 5 will potentially be various shapes, with or without a fairing. It may, for example, take the form of a parallelepipedal block enclosing the various elements of the device. Its shape will potentially depend on and be tailored to the shape of the accommodating housing provided in the vehicle.

The storage unit 6 comprises a casing 60, 90 which may be composed of a plurality of elements that are able to be assembled together.

The storage unit 6 advantageously bears the fastening means that allow the device 5 to be fastened to the vehicle V, for example to its chassis, or to be suitably housed in an accommodating housing of the vehicle. The storage unit 6 also comprises electrical connection means allowing the device to be electrically connected to the electrical supply assembly of the vehicle. These fastening means may be formed on the casing 60.

It will be noted that it will possibly be necessary to provide a specific electrical switching module, arranged in the vehicle to connect or disconnect the device to the electrical supply assembly of the vehicle. This switching module may also be arranged and configured to select the power source of the electrical supply assembly from among various power sources, for example via the aforementioned pedestal 3 and the device 5 according to embodiments of the disclosure or via an electrical plug accessible on the vehicle and connectable manually by the user.

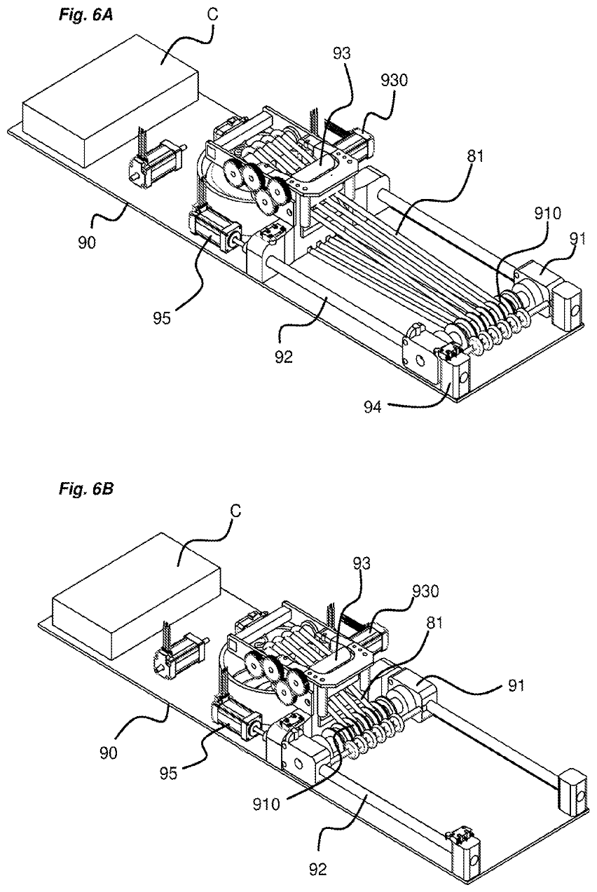

In a first example of an embodiment, illustrated in FIG. 3A and FIG. 3B and in FIG. 4 and FIG. 5, the movement assembly 9 for setting the cable 8 in motion comprises at least one winder 61 housed in its casing 60, on which the cable 8 is wound. The winder 61 may comprise a drum on which the cable 8 is wound. The casing 60 comprises an aperture 67 through which the cable 8 is made, on command, to move in both directions. Depending on the configuration of the drum and the length of the cable, the cable 8 may be wound on the drum in a single turn or in a plurality of turns.

The storage unit 6 also comprises first mechanical means 62 for actuating the drum of the winder 61, which are configured to actuate the drum with a view to winding the cable 8 or unwinding the cable 8. The first mechanical actuating means 62 comprise a motor 620 having an output shaft arranged to drive the drum to rotate in one direction or the other direction in order to wind or unwind the cable 8.

The storage unit 6 may also comprise a device 63 for tensioning the cable 8 on the drum of the winder 61, a pressing roller 630 pressing against the cable 8 in order to hold it against the winding surface of the drum, and guiding rollers 64 arranged to guide the cable 8 at the exit of the winder 61, as it is unwound or wound.

The storage unit 6 may also comprise a first sensor 65, an optical sensor for example, housed in the casing 60 and arranged to monitor the unwound length of cable 8. When a sufficient length of cable is unwound, the sensor 65 is configured to send an electrical signal to the control means C, so that the latter may command the motor to stop.

The storage unit 6 may also comprise a second sensor 66, an end-of-travel sensor for example, housed in the casing 60 and arranged to monitor the wound length of cable 8. A protuberance 80 present on the cable 8 makes it possible to mark the end of the winding movement of the cable. During winding of the cable, when the protuberance encounters the end-of-travel sensor 66, the sensor 66 is configured to send an electrical signal to the control means C, so that the latter may command the motor to stop.

A second example of an embodiment is illustrated in FIG. 6A and FIG. 6B. In this example, the cable 8 may be stripped so that all its wires 81 are dissociated and set in parallel motion. In terms of operation, the principle remains identical to that of a single cable 8 but has certain advantages, notably in terms of bulk and of mechanical stresses exerted on the cable 8.

In this example, the device also comprises a casing 90 (a holder is shown in FIGS. 6A and 6B—a lid being intended to be attached to the holder in order to close the casing 90).

Advantageously, in order to cater for the configuration involving a plurality of cable wires 81, the movement assembly 9 for setting the cable 8 in motion, which is housed in the casing 90, comprises a carriage 91 and a slide mechanism 92 that receives the carriage 91 and over which the carriage 91 is able to slide between at least two positions. By sliding, the carriage 91 pulls on the wires 81 of the cable 8 in order to retract them inward or release them outward.

Each wire 81 may have an end that connects directly to an electrical contact of the plug 2. The second end of each wire 81 is connected to an electrical contact intended to be connected to the electrical supply assembly of the vehicle. The carriage 91 may comprise a plurality of aligned guides 910 forming a distributer. A separate wire 81 may be wound around each guide 910, thus allowing the wires to be easily dissociated.

The first mechanical actuating means 95 may comprise one or more motors arranged to actuate the carriage 91 to translate.

The translational movement occurs in a plane that is transverse with respect to the main direction (A).

Rollers 93 may be provided to guide the wires of the cable toward the outlet aperture formed through the casing 90. A motor 930 may be provided to actuate rotation of a roller 93 and make it easier to set the wires in motion.

End-of-travel sensors 94 are added to detect the two end-of-travel positions of the carriage 91.

The control means C are, for example, housed in a casing fastened to the holder. They are configured to control the first mechanical actuating means 95 by sending the control signal S2.

The translational movement could of course be achieved in other ways, using pistons for example.

In the two embodiments described above, the device 5 also comprises a storage casing 71 for the plug 2.

When the cable 8 (or the wires 81) is (are) retracted, the plug 2 becomes housed in this storage casing 71. This storage casing 71 is reclosable in a seal-tight manner by virtue of a cover 72.

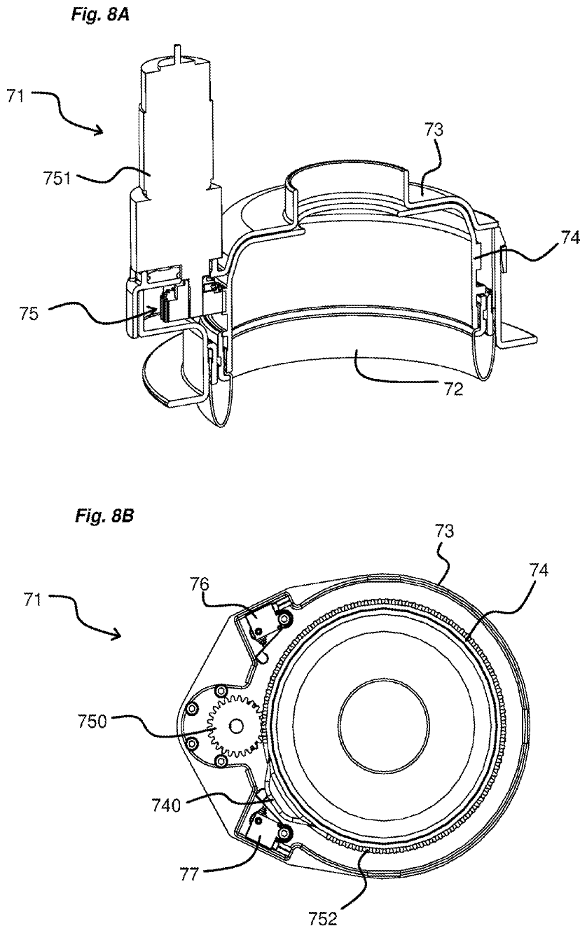

With reference to FIGS. 7A to 8B, the storage casing 71 comprises, for example, a cylindrical external base 73 and a cylindrical internal bell 74 inserted coaxially into the base. The base 73 and the bell 74 are actuatable to rotate with respect to each other, about their axis. Non-limitingly, the bell 74 is actuated to rotate with respect to the base 73.

According to one particular aspect of the disclosure, the cover 72 is formed of a flexible obturating sleeve that has two ends, one end of which is folded over the other so as to have two coaxial lateral flanks connected by a fold. The first end of the sleeve is securely fastened to the base 73 and the second end of the sleeve is securely fastened to the bell 74, by suitable fastening means.

Second actuating means 75 of the device 5 are arranged to actuate the cover 72 to open or close, when the plug 2 must be released in order to be connected to the socket 1 and when the plug 2 is waiting to be connected, respectively.

These second actuating means 75 interact with the bell 74 to drive it to rotate with respect to the base 73, about their axis. The rotation of the bell 74 with respect to the base 73 drives the sleeve in a twisting movement, making it possible to ensure closure of the cover 72.

Non-limitingly, the second actuating means 75 may comprise a gear device comprising a gearwheel 750 that is actuatable to rotate by a motor 751 and notches 752, which engage with the gearwheel, and which are arranged on the external lateral wall of the bell 74. To close the cover 72, rotation of the gearwheel by the motor 751 drives the bell 74 to rotate with respect to the base 73 so as to cause the sleeve to twist.

The second actuating means 75 are controlled by the control means C, on receipt of an electrical control signal.

Detecting means, such as an end-of-travel sensor, may be housed in the storage casing 71 and arranged to mark the end of travel of the bell 74 with respect to the base 73, at the end of opening or at the end of closing. The detecting means are configured to send a stop signal to the motor 751 when the bell 74 has reached the end of its travel, on opening and on closing. The bell 74 may thus bear a finger 740 arranged to interact with a first end-of-travel sensor 76 when the bell 74 has reached the end of its cover-closing movement (FIG. 7B) and to interact with a second end-of-travel sensor 77 when the bell 74 has reached the end of its cover-opening movement (FIG. 8B). The two sensors are fastened to the base 73 and positioned in such a way as to interact with the finger 740 when the bell reaches the end of its opening movement and the end of its closing movement.

In FIG. 7A and FIG. 7B, the cover is closed, closing the storage casing 71 in a seal-tight manner. In FIG. 8A and FIG. 8B, the cover is open, allowing the cable 8 bearing the plug 2 to lower toward the pedestal 3.

The storage casing may be fastened directly to the body of the storage unit 6. In one advantageous variant shown in FIGS. 3A and 3B, the device 5 may comprise a duct 70 fastened to the storage unit 6 at a first end, referred to as the fastening end. At the fastening end, the duct 70 is connected to the exit of the winder 61 and is passed through by the cable 8. Opposite its fastening end, the duct 70 has a free end, bearing the storage casing 71 used to store the plug 2. The duct 70 may have a rigid structure that is not deformable or not very deformable. This duct is also configurable for use in the second embodiment of the device, which was described above with reference to FIGS. 6A and 6B.

According to one particular aspect of the disclosure, with reference to FIG. 9A, FIG. 9B and FIG. 9C, in the context of recharging an electric vehicle, the operating sequence of the device according to the first embodiment is as follows:
the pedestal 3 is placed on the ground S and the vehicle V is advanced until it lies above the pedestal 3 (FIG. 9A);
the presence of the vehicle V may be detected above the pedestal 3, by detecting means M1 of the system. These detecting means M1 send the first electrical control signal S0 to the control means C (FIG. 9B);
on receipt of the first detection signal, the control means C actuate the device of the disclosure;
the control means C send a second electrical control signal 51 to command the second actuating means 75 to open the cover 72, and a third electrical control signal S2 to command the first mechanical actuating means 62 with a view to unwinding the cable 8 from the winder 61;
by unwinding the cable 8, the plug 2 is extracted from the storage casing 71 and directed toward the pedestal 3; and
via magnetic attraction, the plug 2 is first guided by the magnetic means integrated into the pedestal 3, then attracted by the magnetic means of the plug 2 so as to connect to the latter (FIG. 9C).

When the presence of the vehicle is detected, the control means C are thus configured to execute a cable extraction sequence comprising:
opening the cover 72 through activation of the second actuating means 75; and
activating the first mechanical actuating means 62 so as to make the winder 61 rotate and unwind the cable 8 and therefore lower the plug 2. The movement is stopped when the end-of-travel signal sent by the first sensor 65 is received.

Likewise, when the plug 2 is disconnected from the socket 1, the control means are configured to execute a cable storage sequence comprising:
activating the first mechanical actuating means 62 so as to make the winder 61 rotate with a view to raising the plug 2 into the storage casing 71. The movement is stopped on receipt of the end-of-travel signal sent by the second sensor 66; and
closing the cover 72 through activation of the second actuating means 75.

It will be noted that the employed detecting means M1 may be optional.

Specifically, the device may be activated manually by a user when the latter knows that the vehicle is correctly positioned with respect to the pedestal 3. The control unit UC then sends the first electrical control signal S0′ to activate the device 5.

When detecting means M1 suitable for automatic activation are employed, they may be of any type. By way of example, it may be a question of a solution based on radar, of a solution based on an RFID sensor or of a mechanical solution, for example one employing at least one chock intended to interact with a wheel of the vehicle, the chock bearing a presence sensor capable of emitting the first electrical control signal S0. Non-limitingly, this presence sensor may be a position switch, advantageously one that is stand-alone in terms of electrical power, incorporating a converter of mechanical energy (delivered through the pressure of the vehicle) into electrical energy capable of powering a radio transmitter configured to transmit the signal S0.

The sequence described above with reference to FIGS. 9A to 9C may of course be transposed in an identical manner to the second example of an embodiment of the device. In this solution, all the wires are released or retracted. Actuation of the winder 61 is replaced by actuation of the translational movement of the carriage 91 over the slide mechanism 92.

The disclosed embodiments thus have many advantages, among which:
they provide a simple solution that is easily fittable on an electric vehicle to make it compatible with recharging via the system described above;
they use simple and reliable components; and
by virtue of its seal-tight architecture and of its operating mode, the device 5, according to the disclosed embodiments, may remain permanently in the vehicle V.

1. A device, fittable on an electrical apparatus with a view to recharging the electrical apparatus, the device comprising:
a storage unit comprising a cable bearing an electrical plug at an end of the cable, a movement assembly for setting the cable in motion, first mechanical actuating means for actuating the movement assembly, the first mechanical actuating means being configured to actuate the movement assembly with a view to releasing the cable outwardly from the storage unit or to retracting the cable into the storage unit;
a storage casing in which the electrical plug is housed when the cable is retracted, the storage casing bearing an obturating device that comprises a cover that is actuatable to open or close;
second mechanical actuating means controlled to open or close the cover; and
control means for controlling the first mechanical actuating means so as to release or retract the cable and for controlling the second mechanical actuating means so as to open or close the cover, the control means being configured to receive an electrical control signal from detecting means or a control unit.

2. The device of claim 1, further a guiding device comprising a duct for guiding the cable, the duct being fastened to the storage unit and arranged to guide the cable, the duct having a free end bearing the storage casing.

3. The device of claim 1, wherein the storage casing comprises a base and a bell that are actuatable to rotate with respect to each other by the second mechanical actuating means.

4. The device of claim 3, wherein the cover comprises a flexible obturating sleeve having a first end and a second end, the second end being folded over the first end so as to have two coaxial lateral flanks connected by a fold, the first end being fastened to the base, and the second end being fastened to the bell.

5. The device of claim 3, wherein the second mechanical actuating means comprise a gearwheel engaged with teeth formed on the bell.

6. The device of claim 1, wherein the storage casing comprises:
a first sensor for sensing an end of a closing movement of the cover; and
a second sensor for sensing an end of an opening movement of the cover,
the sensors each being arranged to interact with a finger that is securely fastened to the bell.

7. The device of claim 1, wherein the movement assembly comprises a winder on which the cable is intended to be wound.

8. The device of claim 7, wherein the storage unit comprises a first sensor arranged to monitor a length of the cable unwound from the winder.

9. The device of claim 8, wherein the storage unit further comprises a second sensor arranged to monitor a length of the cable wound on the winder.

10. The device of claim 1, wherein the movement assembly comprises a carriage that is translatable on a slide mechanism.

11. An electrical connection system, comprising an electrical plug and an electrical socket that are able to be coupled together to make an electrical connection, wherein the electrical plug is borne by the device of claim 1.

12. The electrical connection system of claim 11, further comprising a pedestal comprising a jacket having a central part occupied by the electrical socket.

13. The electrical connection system of claim 12, further comprising:
a plurality of guide coils housed in the jacket of the pedestal and arranged concentrically around the electrical socket; and
control means configured to execute a control sequence in which each coil of the plurality of guide coils is independently activatable to move the electrical plug closer to the electrical socket through creation of a magnetic field.

14. An electric or hybrid vehicle, comprising a chassis to which the device of claim 1 is fastened.
